(19) United States
(12) Patent Application Publication
(10) Pub. No.: US 2024/0186619 A1
(43) Pub. Date: Jun. 6, 2024

(54) BATTERY DEVICE AND HEAT-COMPENSATION SERIAL COOLING MODULE THEREOF

(71) Applicant: AMITA TECHNOLOGIES INC., Taoyuan City (TW)

(72) Inventor: Yuan-Li CHIANG, Taoyuan City (TW)

(21) Appl. No.: 18/301,747

(22) Filed: Apr. 17, 2023

(30) Foreign Application Priority Data
Dec. 6, 2022 (TW) 111146687

(51) Int. Cl. H01M 10/6568; H01M 10/613; H01M 10/6556

(52) U.S. Cl. CPC H01M 10/6568; H01M 10/613; H01M 10/6556; H01M 2220/20

(57) ABSTRACT

The disclosure provides a heat-compensation serial cooling module including a heat exchanger, a cooling element, a pump, and a working fluid. The heat exchanger includes multiple heat exchanging portions. The heat exchange loop includes a main heat exchange pipeline and a compensational heat exchange pipeline serially connected to the heat exchanging portions. The main heat exchange pipeline and the compensational heat exchange pipeline are arranged parallelly and adjacently. The pump drives the working fluid to circulate in the heat exchange loop. A flowing direction of the working fluid in the main heat exchange pipeline is opposite to a flowing direction of the working fluid in the compensational heat exchange pipeline. The temperature of the compensational heat exchange pipeline is higher than that of the heat exchanging portions to compensate heat to make the temperature of each heat exchanging portion be approximately the same.

### BACKGROUND

### Technical Field

The disclosure relates to a battery cooling, particularly to a battery device and a heat-compensation serial cooling module thereof.

### Description of Related Art

A battery device carried in an electric vehicle includes multiple battery modules and the battery modules are separately disposed with cooling assemblies. A related-art cooling assembly is composed of a serial circulation pipeline. That is, each battery module is connected in the circulation pipeline in series. Working fluid in the circulation pipeline flows through each battery module in order to take away the heat generated by each battery module and then is dissipated by a cooler, and finally flows back to each battery module. However, after the working fluid passes one battery module, the working fluid is heated up after absorbing heat generated by the battery module. The temperature difference between the working fluid and the battery module is decreased and cause loss of the heat exchange ability. Thus, the cooling efficiency of working fluid to each battery module is not uniform and the battery modules are unable to be kept at the same temperature. The inconsistency of working temperature of the battery modules reduces the charging and discharging efficiency of each battery module and shortens the service life of each battery module.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

The disclosure provides a battery device and a heat-compensation serial cooling module thereof.

The disclosure provides a heat-compensation serial cooling module including at least one heat exchanger, at least one cooling element, a pump, and a working fluid. The heat exchanger includes multiple heat exchanging portions. The heat exchange loop is connected to the heat exchanging portions and the cooling element in series. The heat exchange loop includes a main heat exchange pipeline and a compensational heat exchange pipeline communicating with the main heat exchange pipeline. The main heat exchange pipeline and the compensational heat exchange pipeline are separately connected to the heat exchanging portions in series. The main heat exchange pipeline and the compensational heat exchange pipeline are arranged parallelly and adjacently in each heat exchanging portion. The pump is connected in the heat exchange loop in series. The working fluid is received in the heat exchange loop. The pump drives the working fluid to circulate in the heat exchange loop. A flowing path of the working fluid is starting from the cooling element, passing through the main heat exchange pipeline and the compensational heat exchange pipeline in order and flowing back to the cooling element. A flowing direction of the working fluid in the main heat exchange pipeline is opposite to a flowing direction of the working fluid in the compensational heat exchange pipeline, when the working fluid passes through the heat exchanging portions. The temperature of the compensational heat exchange pipeline is higher than that of at least one of the heat exchanging portions.

In an embodiment of the disclosure, the main heat exchange pipeline has a main outlet end, the compensational heat exchange pipeline has a compensational inlet end, and the main outlet end is connected with the compensational inlet end.

In an embodiment of the disclosure, the main heat exchange pipeline has a main inlet end, the compensational heat exchange pipeline has a compensational outlet end, and the pump is arranged on a flowing path of the working fluid between the main inlet end and the compensational outlet end.

In an embodiment of the disclosure, the main heat exchange pipeline has a main inlet end, the compensational heat exchange pipeline has a compensational outlet end, and the cooling element is arranged on a flowing path of the working fluid between the main inlet end and the compensational outlet end.

In an embodiment of the disclosure, the heat-compensation serial cooling module further includes a water tank connected to the heat exchange loop and arranged on a flowing path of the working fluid between the main inlet end and the compensational outlet end. The cooling element is arranged on a flowing path of the working fluid between the water tank and the compensational outlet end.

In an embodiment of the disclosure, an order of the working fluid passing through the heat exchanging portions by the main heat exchange pipeline is opposite to an order of the working fluid passing through the heat exchanging portions by the compensational heat exchange pipeline.

In an embodiment of the disclosure, two ends of the main heat exchange pipeline are a main inlet end and a main outlet end, respectively, and the heat exchanging portions are connected between the main inlet end and the main outlet end in series.

In an embodiment of the disclosure, two ends of the compensational heat exchange pipeline are a compensational inlet end and a compensational outlet end, respectively, and the heat exchangers are connected between the compensational inlet end and the compensational outlet end in series.

The disclosure further provides a battery device, which includes multiple battery modules and an abovementioned heat-compensation serial cooling module. The heat exchanging portions are arranged corresponding to the battery modules. Each heat exchanging portion is separately attached on corresponding one of the battery modules.

In the battery device and the heat-compensation serial cooling module thereof of the disclosure, the working fluid passes through each heat exchanging portion of the heat exchange pipeline to make the temperature of the working fluid gradually rise. The temperature of the working fluid passing through the compensational heat exchange pipeline is higher than that of at least one of the heat exchanging portions, so that of the heat carried by the working fluid in the compensational heat exchange pipeline is transferred to each one of the heat exchanging portions, which has a lower temperature, to compensate the temperature difference between the heat exchanging portions. Therefore, each heat exchanging portion is approximately the same in temperature, so the battery modules may be kept at an approximately the same working temperature to maintain the working status with the same temperature of the battery device.

### BRIEF DESCRIPTION OF THE DRAWINGS

FIG. 1 is a structural schematic view of the battery device of the first embodiment of the disclosure;

FIG. 2 is a schematic view of the working flow path of the working fluid of the battery device of the disclosure; and

FIG. 3 is a structural schematic view of the battery device of the second embodiment of the disclosure;

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

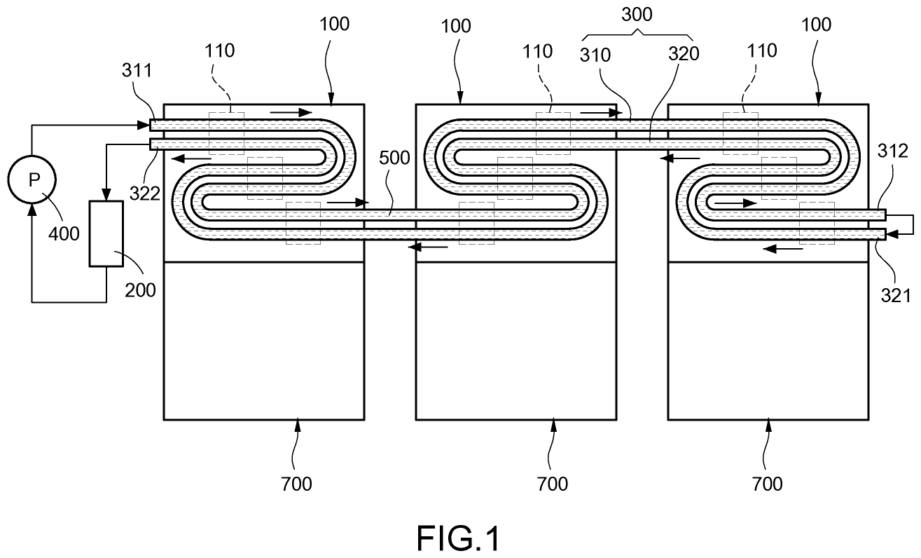

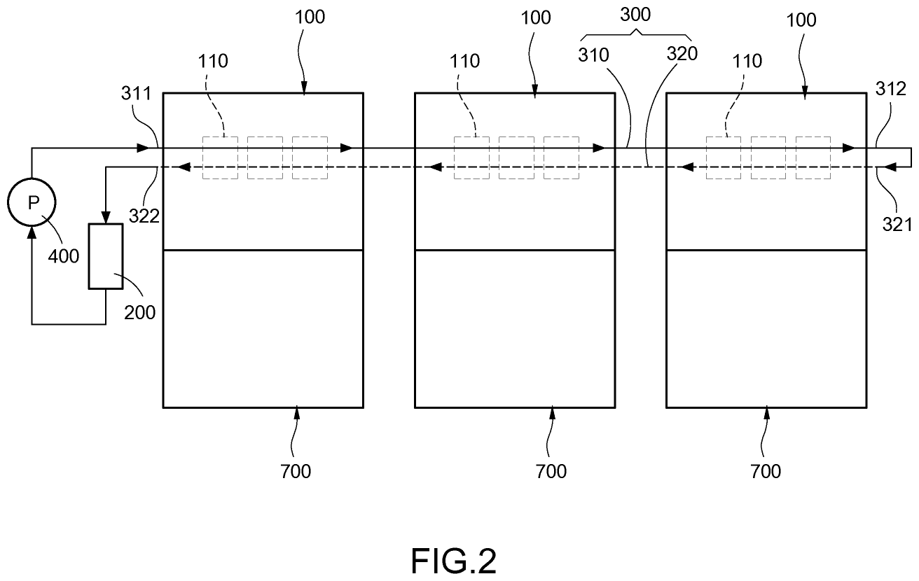

Please refer to FIGS. 1 and 2. An embodiment of the disclosure provides a battery device and a heat-compensation serial cooling module thereof. The battery device is carried in an electric vehicle and includes multiple battery modules 700 and said heat-compensation serial cooling module.

FIG. 1 shows a structural schematic view of the heat-compensation serial cooling module of the disclosure. The heat-compensation serial cooling module of the disclosure includes at least one heat exchanger 100, at least one cooling element 200, a heat exchange loop 300, a pump 400 and working fluid 500. FIG. 2 shows a schematic view of the working flow path of the working fluid 500 of the heat-compensation serial cooling module of the disclosure.

The disclosure does not limit the type of the heat exchanger 100. In the embodiment, the heat exchanger 100 may be a plate or a block made of copper or aluminum. Each heat exchanger 100 is arranged corresponding to one of the battery modules 700. In detail, each heat exchanger 100 is separately attached on corresponding one of the battery modules 700. The at least one heat exchanger 100 includes multiple heat exchanging portions 110. The heat exchanging portions 110 may be disposed at multiple heat exchangers 100 or the same one heat exchanger 100.

The heat exchange loop 300 is a closed circulation pipeline composed of metal pipes (such as copper or aluminum) or plastic soft tubes connected in series. The working fluid 500 is filled in the heat exchange loop 300. In the embodiment, the heat exchange loop 300 is connected with the heat exchanging portions 100 in series. Each heat exchanging portion 110 is a position at which the heat exchange loop 300 implements heat exchange in the heat exchanger 100. In a single heat exchanger 100, multiple adjacent heat exchanging portions 110 may be connected in a row. The heat exchange loop 300 includes a main heat exchange pipeline 310 and a compensational heat exchange pipeline 320 communicating with the main heat exchange pipeline 310. The main heat exchange pipeline 310 and the compensational heat exchange pipeline 320 are separately connected to the heat exchanging portions 110 in series. The main heat exchange pipeline 310 and the compensational heat exchange pipeline 320 are arranged parallelly and closely adjacent to each other at least in each heat exchanging portion 110. Some portions of the main heat exchange pipeline 310 and the compensational heat exchange pipeline 320 may be embedded in or buried in the heat exchangers 100, or pipelines may be formed in each of the heat exchangers 100 to constitute some portions of the main heat exchange pipeline 310 and the compensational heat exchange pipeline 320.

In the embodiment, parts of the main heat exchange pipeline 310 and the compensational heat exchange pipeline 320, which pass the heat exchanger 100, are made of metal to have heat exchange with each heat exchanging portion 110. Other parts of the heat exchange loop 300 may be serially connected by soft tubes to be advantageous in arrangement and installation. Two ends of the main heat exchange pipeline 310 are a main inlet end 311 and a main outlet end 312, respectively. The heat exchanging portions 110 are connected between the main inlet end 311 and the main outlet end 312 in series. The main heat exchange pipeline 310 may be bendingly or serpentinely arranged in each heat exchanger 100 to extend the heat exchange length between the main heat exchange pipeline 310 and the heat exchanger 100. Two ends of the compensational heat exchange pipeline 320 are a compensational inlet end 321 and a compensational outlet end 322, respectively. The heat exchanging portions 110 are connected between the compensational inlet end 321 and the compensational outlet end 322 in series. The compensational heat exchange pipeline 320 may be bendingly arranged in the heat exchanger 100 to extend the heat exchange length between the compensational heat exchange pipeline 320 and the heat exchanger 100. The main outlet end 312 is connected to the compensational inlet end 321 to connect the main heat exchange pipeline 310 and the compensational heat exchange pipeline 320 in series, so as to make the working fluid 500 re-flow through the compensational heat exchange pipeline 320 after passing through the main heat exchange pipeline 310.

In the embodiment, the cooling element 200 may be implemented by a cooler with fins. The cooling element 200 may be made of copper or aluminum. The cooling element 200 is connected to the heat exchange loop 200 in series. The cooling element 200 on the flowing path of the working fluid 500 is arranged between a water tank 600 and the compensational outlet end 322.

The pump 400 is connected in the heat exchange loop 300 in series to drive the working fluid 500 to circulate in the heat exchange loop 300. Also, the pump 300 is arranged between the main inlet end 311 and the compensational outlet end 322 on the flowing path of the working fluid 500. In detail, the pump 400 pumps the working fluid 500 in the main heat exchange pipeline 310 through the main inlet end 311.

A flowing path of the working fluid 500 is starting from the cooling element 200, passing through the main heat exchange pipeline 310 and the compensational heat exchange pipeline 320 in order, and flowing back to the cooling element 200. The order of the working fluid 500 passing through the heat exchanging portions 110 by the main heat exchange pipeline 310 is opposite to the order of the working fluid 500 passing through the heat exchanging portions 110 by the compensational heat exchange pipeline 320. The flowing direction of the working fluid 500 in the main heat exchange pipeline 310 is opposite to the flowing direction of the working fluid 500 in the compensational heat exchange pipeline 320, when the working fluid 500 passes through the heat exchanging portions 110.

Please refer to FIG. 2. When each battery module 700 of the battery module is working, the working fluid 500 cooled by the cooling element 200 passes through the heat exchange pipeline by each heat exchanging portion 110 to make the temperature of the working fluid 500 gradually rise. The temperature of the working fluid 500 leaving the main heat exchange pipeline 310 through the main outlet end 312 is higher than the temperature of at least one of the heat exchanging portions 110, so after the working fluid 500 leaves the main heat exchange pipeline 310 to enter the compensational heat exchange pipeline 320, the working fluid 500 in the compensational heat exchange pipeline 320 transfers carried heat to each heat exchanging portion 110, which has a lower temperature, to compensate the temperature difference between the heat exchanging portions 110. The working fluid 500 in the compensational heat exchange pipeline 320 still absorbs heat from each heat exchanging portion 110 which has a higher temperature than itself.

The flowing directions of the working fluid 500 in the main heat exchange pipeline 310 and the compensational heat exchange pipeline 320 are opposite, so that the working fluid 500 in the main heat exchange pipeline 310 has temperature differences corresponding to the heat exchanging portions 110 sequentially decreasing, and the working fluid 500 in the compensational heat exchange pipeline 320 has temperature differences corresponding to the heat exchanging portions 110 gradually increasing. Thus, the working fluid 500 in compensational heat exchange pipeline 320 also compensates heats to the heat exchanging portions 110 sequentially decreased in amount, i.e., the heat exchanging portion 110 having a lower temperature is compensated for more heat.

The above compensational heat exchange pipeline 320 makes the temperature of each heat exchanging portion approximately identical, so the working temperatures of the battery modules 700 may be kept approximately identical to keep the battery device in a working status with a uniform temperature.

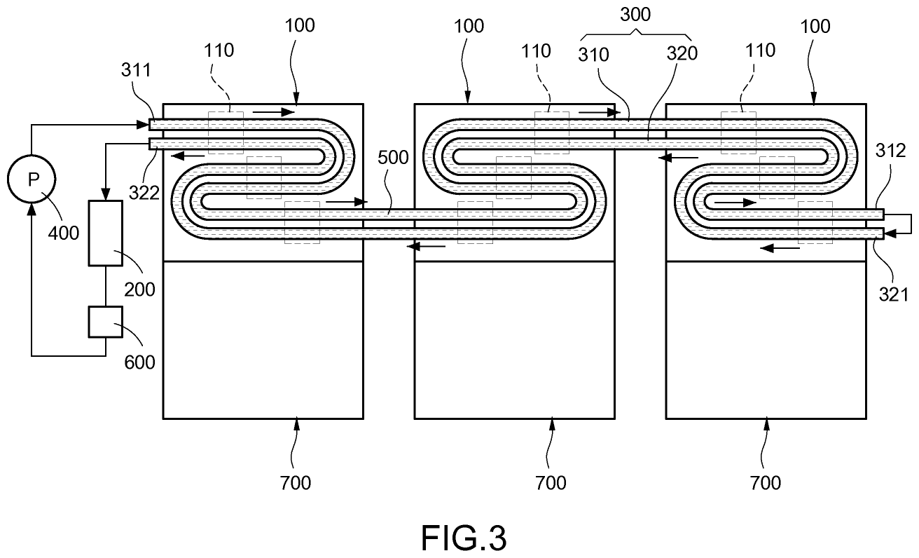

Please refer to FIG. 3. Another embodiment of the disclosure provides a battery device and the heat-compensation serial cooling module thereof. Its structure is substantially the same as the above first embodiment, so the description of the same parts is omitted for brevity. The difference between the present embodiment and the above embodiment is that the heat-compensation serial cooling module of the embodiment further includes a water tank 600. The water tank 600 is connected to the heat exchange loop 300 and is arranged on the flowing path of the working fluid 500 between the main inlet end 311 and the compensational outlet end 322. Apart from the flowing working fluid, the water tank 600 may store more working fluid 500 to serve as a buffer or to avoid the loss of the working fluid 500 which makes the pump 400 idle and causes damage to the pump 400. The cooling element 200 is arranged on the flowing path of the working fluid 500 between the water tan 600 and the compensational outlet end 322. As a result, the working fluid 500, which is collected and cooled in the water tank 600, may be re-pumped into the main heat exchange pipeline 310 to prevent the working fluid 500, which is not sufficiently cooled, from being pumped into the main heat exchange pipeline 310.

While this disclosure has been described by means of specific embodiments, numerous modifications and variations could be made thereto by those skilled in the art without departing from the scope and spirit of this disclosure set forth in the claims.

What is claimed is:

1. A heat-compensation serial cooling module comprising:
at least one heat exchanger, comprising multiple heat exchanging portions;
at least one cooling element;
a heat exchange loop, passing the at least one heat exchanger to connect the heat exchanging portions as a series, comprising a main heat exchange pipeline and a compensational heat exchange pipeline communicating with the main heat exchange pipeline, the main heat exchange pipeline and the compensational heat exchange pipeline separately serially passing the heat exchanging portions, and the main heat exchange pipeline and the compensational heat exchange pipeline arranged parallelly and adjacently in each heat exchanging portion;
a pump, serially connected to the heat exchange loop; and
a working fluid, received in the heat exchange loop;
wherein the pump is configured to drive the working fluid to circulate in the heat exchange loop, a flowing path of the working fluid is starting from the cooling element, sequentially passing through the main heat exchange pipeline, the compensational heat exchange pipeline and flowing back to the cooling element, when the working fluid passes through the heat exchanging portions, a flowing direction of the working fluid in the main heat exchange pipeline is opposite to a flowing direction of the working fluid in the compensational heat exchange pipeline, and a temperature of the working fluid in the compensational heat exchange pipeline is higher than a temperature of at least one of the heat exchanging portions.

2. The heat-compensation serial cooling module of claim 1, wherein the main heat exchange pipeline comprises a main outlet end, the compensational heat exchange pipeline comprises a compensational inlet end, and the main outlet end is connected with the compensational inlet end.

3. The heat-compensation serial cooling module of claim 1, wherein the main heat exchange pipeline comprises a main inlet end, the compensational heat exchange pipeline comprises a compensational outlet end, and the pump is arranged on the flowing path of the working fluid between the main inlet end and the compensational outlet end.

4. The heat-compensation serial cooling module of claim 1, wherein the main heat exchange pipeline comprises a main inlet end, the compensational heat exchange pipeline comprises a compensational outlet end, and the cooling element is arranged on the flowing path of the working fluid between the main inlet end and the compensational outlet end.

5. The heat-compensation serial cooling module of claim 1, further comprising a water tank serially connected to the heat exchange loop, wherein the main heat exchange pipeline comprises a main inlet end, the compensational heat exchange pipeline comprising a compensational outlet end, and the water tank is arranged on the flowing path of the working fluid between the main inlet end and the compensational outlet end.

6. The heat-compensation serial cooling module of claim 5, wherein the cooling element is arranged on the flowing path of the working fluid between the water tank and the compensational outlet end.

7. The heat-compensation serial cooling module of claim 1, wherein an order of the working fluid passing through the heat exchanging portions by the main heat exchange pipeline is opposite to an order of the working fluid passing through the heat exchanging portions by the compensational heat exchange pipeline.

8. The heat-compensation serial cooling module of claim 1, wherein two ends of the main heat exchange pipeline are a main inlet end and a main outlet end, respectively, and the heat exchanging portions are serially connected between the main inlet end and the main outlet end.

9. The heat-compensation serial cooling module of claim 1, wherein two ends of the compensational heat exchange pipeline are a compensational inlet end and a compensational outlet end, respectively, and the heat exchanging portions are serially connected between the compensational inlet end and the compensational outlet end.

10. A battery device comprising:
multiple battery modules; and
a heat-compensation serial cooling module as claimed in claim 1, wherein the heat exchanging portions are arranged corresponding to the battery modules, and each heat exchanging portion is separately attached on each battery module.

11. The battery device of claim 10, wherein the main heat exchange pipeline comprises a main outlet end, the compensational heat exchange pipeline comprises a compensational inlet end, and the main outlet end is connected with the compensational inlet end.

12. The battery device of claim 10, wherein the main heat exchange pipeline comprises a main inlet end, the compensational heat exchange pipeline comprises a compensational outlet end, and the pump is arranged on the flowing path of the working fluid between the main inlet end and the compensational outlet end.

13. The battery device of claim 10, wherein the main heat exchange pipeline comprises a main inlet end, the compensational heat exchange pipeline comprises a compensational outlet end, and the cooling element is arranged on the flowing path of the working fluid between the main inlet end and the compensational outlet end.

14. The battery device of claim 10, further comprising a water tank serially connected to the heat exchange loop and arranged on the flowing path of the working fluid between the main inlet end and the compensational outlet end.

15. The battery device of claim 14, wherein the cooling element is arranged on the flowing path of the working fluid between the water tank and the compensational outlet end.

16. The battery device of claim 10, wherein an order of the working fluid passing through the heat exchanging portions by the main heat exchange pipeline is opposite to an order of the working fluid passing through the heat exchanging portions by the compensational heat exchange pipeline.

17. The battery device of claim 10, wherein two ends of the main heat exchange pipeline are a main inlet end and a main outlet end, respectively, and the heat exchanging portions are serially connected between the main inlet end and the main outlet end.

18. The battery device of claim 10, wherein two ends of the compensational heat exchange pipeline are a compensational inlet end and a compensational outlet end, respectively, and the heat exchanging portions are serially connected between the compensational inlet end and the compensational outlet end.
